(19) United States
(12) Patent Application Publication
(10) Pub. No.: US 2017/0136952 A1
(43) Pub. Date: May 18, 2017

(54) ELECTRONIC COMPASS DEVICE FOR VEHICLE, PORTABLE ELECTRONIC COMPASS CALIBRATION DEVICE, CONTROL PROGRAM FOR PORTABLE ELECTRONIC COMPASS CALIBRATION DEVICE, AND ELECTRONIC COMPASS CALIBRATION SYSTEM FOR VEHICLE

(71) Applicant: Panasonic Intellectual Property Management Co. , Ltd., Osaka (JP)

(72) Inventor: MASAHIRO OHNO, Hokkaido (JP)

(21) Appl. No.: 15/320,784

(22) PCT Filed: Jun. 30, 2015
(86) PCT No.: PCT/JP2015/003279

§ 371 Date: Dec. 21, 2016

(30) Foreign Application Priority Data
Jul. 3, 2014 (JP) 2014-137832

(51) Int. Cl. B60R 1/12; G01C 17/38; H04N 5/232; G01C 17/32; B60R 1/04; B60K 35/00

(52) U.S. Cl. CPC B60R 1/12; B60R 1/04; B60K 35/00; H04N 5/23293; G01C 17/32; G01C 17/38; B60R 2001/1215; B60R 2001/1223; B60R 2001/1253; B60K 2350/927; B60K 2350/352; B60K 2350/2013; B60R 2300/402; B60R 2300/8066

(57) ABSTRACT

The electronic compass device for a vehicle is installed in an attachment position of a rearview mirror inside a vehicle interior, and is connected to a coupling body disposed on a windshield of a vehicle in parallel with a centerline of the vehicle. Then, the electronic compass device for a vehicle displays a compass calibration screen in accordance with a signal received from the portable electronic compass calibration device. The portable electronic compass calibration device creates calibration information by using the acquired image of the compass calibration screen and the coupling body, and the bearing of the electronic compass at the time of acquiring the image so as to transmit the created calibration information to the electronic compass device for a vehicle. The electronic compass device for a vehicle calibrates the bearing in the traveling direction of the vehicle based on the received calibration information.

### TECHNICAL FIELD

The present invention relates to an electronic compass device for a vehicle having a function of receiving calibration information for calibrating a deviation of a bearing.

### BACKGROUND ART

As a conventional electronic compass device for a vehicle with a calibration function, an electronic compass device including a magnetic sensor disposed in a rearview mirror of the vehicle, the electronic compass device causing a display device embedded in the rearview mirror to display a bearing in a traveling direction of a vehicle is known (see, for example, PTL 1).

The magnetic sensor of the electronic compass device for a vehicle detects magnetic components in three directions of a traveling direction of a vehicle, a width direction of a vehicle, and a height direction of a vehicle. When detecting the abrupt change in the magnetic component in the height direction of a vehicle, the electronic compass device for a vehicle determines that a magnetic noise is present, and performs calibration of a deviation between a bearing to be calculated by the electronic compass and an actual bearing.

### CITATION LIST

### Patent Literature

PTL 1: Unexamined Japanese Patent Publication No. 2010-271138

### SUMMARY OF THE INVENTION

The present invention provides an electronic compass device for a vehicle capable of calibrating a bearing in a traveling direction of the vehicle without moving of the vehicle.

The electronic compass device for a vehicle of the present invention is installed in an attachment position of a rearview mirror inside a vehicle interior, and connected to a coupling body disposed on a windshield of a vehicle in parallel with a centerline of the vehicle. The electronic compass device for a vehicle includes a communication unit, a display unit, and a controller. The communication unit communicates with a portable electronic compass calibration device including an electronic compass having a calibration function. The display unit displays a bearing in a traveling direction of the vehicle. The controller controls the communication unit and the display unit. The display unit displays a compass calibration screen in accordance with a signal received by the communication unit from the portable electronic compass calibration device. The communication unit receives calibration information obtained by a calculation of the portable electronic compass calibration device by using an acquired image of the compass calibration screen and the coupling body, and a bearing of the electronic compass at a time of acquiring of the acquired image after calibration of the portable electronic compass calibration device. The controller calibrates a bearing in a traveling direction of the vehicle to be displayed on the display unit based on the calibration information.

On the other hand, the portable electronic compass calibration device of the present invention includes a communication unit, an electronic compass having a calibration function, a camera, a display unit, and a controller. The communication unit communicates with the electronic compass device for a vehicle. The display unit displays an image acquired by the camera. The controller controls the communication unit, the electronic compass, the camera, and the display unit. The camera acquires an image of a compass calibration screen to be displayed by the electronic compass device for a vehicle and a coupling body disposed on a windshield of the vehicle in parallel with a centerline of the vehicle connected to the electronic compass device for a vehicle as one image. The controller calculates a bearing in a traveling direction of the vehicle to be displayed by the electronic compass device for a vehicle based on the image and an output of the electronic compass after calibration at a time of acquiring of the image. The communication unit transmits a command for instructing a display of the compass calibration screen and a bearing calculated by the controller to the electronic compass device for a vehicle.

It should be noted that here, “a traveling direction of a vehicle” is synonymous with “a front of a vehicle” and “a direction of a vehicle”.

The electronic compass device for a vehicle of the present invention receives the calibration information from the portable electronic compass calibration device including the electronic compass having a calibration function, and calibrates the bearing in the traveling direction of the vehicle to be displayed on the display unit based on the received calibration information.

After calibration of the electronic compass due to the movement in a predetermined direction, the portable electronic compass calibration device of the present invention acquires the compass calibration screen of the electronic compass device for a vehicle and the coupling body as one image. The portable electronic compass calibration device calculates the bearing in the traveling direction of the vehicle to be displayed by the electronic compass device for a vehicle by using the acquired image and the output of the electronic compass at the time of acquiring the image so as to transmit the calculation result to the electronic compass device for a vehicle as the calibration information.

Therefore, the electronic compass device for a vehicle can calibrate the bearing in the traveling direction of the vehicle without moving of the electronic compass device for a vehicle, in other words, without moving of the vehicle.

### BRIEF DESCRIPTION OF DRAWINGS

FIG. 1A is a perspective view of an electronic compass device for a vehicle disposed inside the vehicle interior according to an exemplary embodiment of the present invention.

FIG. 1B is a side view of the electronic compass device for a vehicle disposed inside the vehicle interior according to the exemplary embodiment of the present invention.

FIG. 2 is a diagram showing the front and bottom surfaces of the electronic compass device for a vehicle according to the exemplary embodiment of the present invention.

FIG. 3 is a block diagram illustrating a configuration of the electronic compass device for a vehicle according to the exemplary embodiment of the present invention.

FIG. 4 is a block diagram illustrating a configuration of a portable electronic compass calibration device according to the exemplary embodiment of the present invention.

FIG. 5 is a diagram illustrating the operations of the electronic compass device for a vehicle and the portable electronic compass calibration device.

FIG. 6 is a flowchart showing an example of the operation of the portable electronic compass calibration device according to the exemplary embodiment of the present invention.

FIG. 7 is a flowchart showing an example of the operation of the electronic compass device for a vehicle according to the exemplary embodiment of the present invention.

### DESCRIPTION OF EMBODIMENT

The calibration of the bearing in the conventional electronic compass device for a vehicle needs to cause the vehicle to move, for example, by the driving of the vehicle into one turning around in any direction. It is difficult to calibrate the bearing before the driving of a vehicle, that is, before the moving of a vehicle.

In the following, the electronic compass device for a vehicle according to an exemplary embodiment of the present invention will be described with reference to the accompanying drawings.

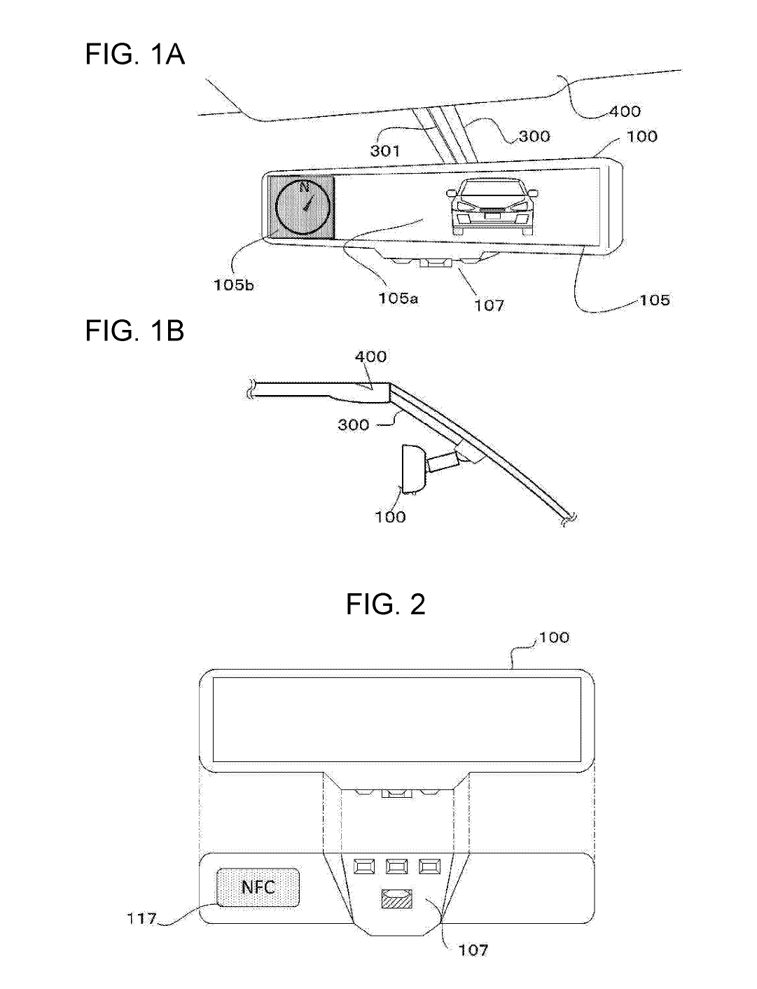

FIGS. 1A and 1B are respectively a perspective view and a side view of electronic compass device for a vehicle 100 in the present exemplary embodiment disposed inside a vehicle interior. Electronic compass device for a vehicle 100 is installed with an attachment member (not shown) in an attachment position of a rearview mirror inside the vehicle interior of vehicle 400. Electronic compass device for a vehicle 100 is movably and adjustably attached to the attachment member.

Electronic compass device for a vehicle 100 has a function of an electronic mirror for displaying an image acquired by a camera mounted on the vehicle.

Electronic compass device for a vehicle 100 is connected to coupling body 300 storing a cable harness for connecting another apparatus such as a camera mounted on vehicle 400 with electronic compass device for a vehicle 100.

Coupling body 300 is disposed on a windshield of the vehicle in parallel with a centerline of the vehicle such as an axle. Coupling body 300 has centerline 301 by printing or recess-shaped groove processing in the front of the components on the vehicle ceiling side (driver's side).

A display screen image on display unit 105 of electronic compass device for a vehicle 100 is identifiably divided into region 105a for displaying an image acquired by a camera as an electronic mirror and region 105b for displaying the bearing in the traveling direction of vehicle 400 (hereinafter, assuming that “a traveling direction of a vehicle” is synonymous with “a front of a vehicle” and “a direction of a vehicle”, “a traveling direction of a vehicle” will be used).

In region 105b for displaying the bearing in the traveling direction of vehicle 400, the bearing in the traveling direction of vehicle 400 is displayed by a triangle with North as a vertically upward direction. The bearing in the traveling direction of vehicle 400 is displayed intermittently, for example, at an interval of 100 ms so that image burn-in is prevented.

It should be noted that a half mirror (not shown) is disposed on the driver's side of display unit 105, and the image to be displayed on display unit 105 is recognized by the driver via the half mirror. When display unit 105 is turned OFF, or in a part where the image of display unit 105 is not displayed, the half mirror functions as a rearview mirror.

FIG. 2 is a diagram showing the front and bottom surfaces of electronic compass device for a vehicle 100. On the bottom surface of vehicle 400 of electronic compass device for a vehicle 100, operation unit 107 including a plurality of switches for operating the electronic mirror is disposed as illustrated in FIG. 2.

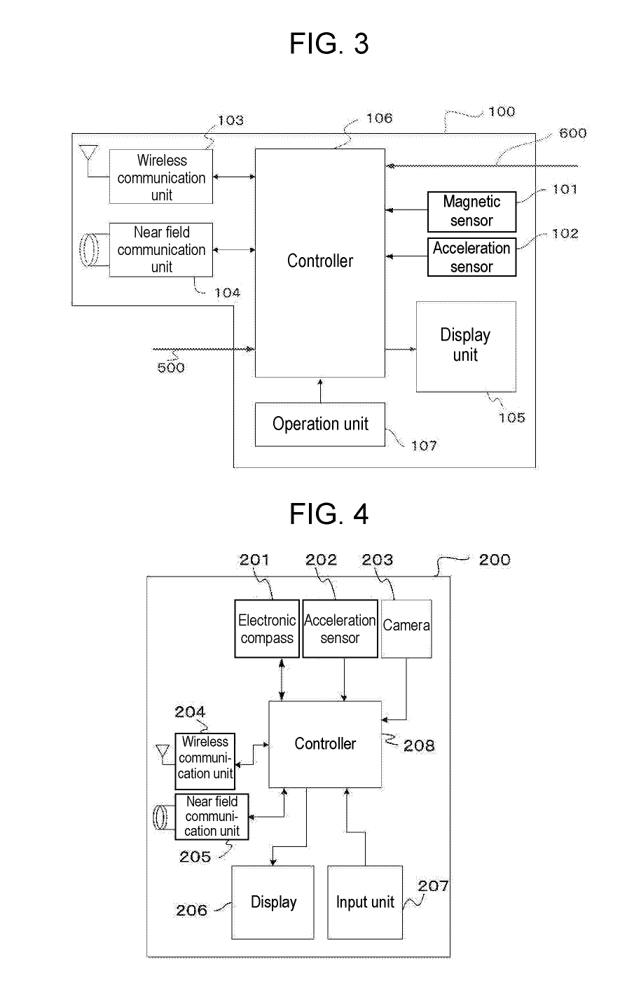

In addition, mark 117 for indicating the position where an antenna of near field communication unit 104 described below (see FIG. 3) of electronic compass device for a vehicle 100 is disposed is provided.

FIG. 3 is a block diagram illustrating a configuration of electronic compass device for a vehicle 100. Electronic compass device for a vehicle 100 includes wireless communication unit 103 and near field communication unit 104 as communication units performing wireless communication with portable electronic compass calibration device 200 described below (see FIG. 4) as illustrated in FIG. 3. Wireless communication unit 103 performs communication based on, for example, Bluetooth (registered trademark), and near field communication unit 104 performs communication based on NFC (Near Field Communication).

Electronic compass device for a vehicle 100 includes magnetic sensor 101 configured to detect geomagnetism, acceleration sensor 102 configured to detect the movement of electronic compass device for a vehicle 100, display unit 105 configured to display the bearing in the traveling direction of the vehicle and camera image 500 obtained by acquiring an image of the rear of the vehicle, operation unit 107 configured to turn ON and OFF display unit 105, and controller 106 configured to control the operation of electronic compass device for a vehicle 100. Display unit 105 is, for example, constituted of a liquid crystal display.

Controller 106 includes a CPU (central processing unit) configured to control operation, a ROM (read-only memory) configured to store a control program, and a RAM (random-access memory) configured to store data to be temporarily held and control data.

Electronic compass device for a vehicle 100 is also used as a rearview mirror, and therefore the direction of electronic compass device for a vehicle 100 and the direction of the vehicle are usually different.

Controller 106 identifies the positional relation between the vehicle and electronic compass device for a vehicle 100, and calculates the bearing in the traveling direction of the vehicle from the geomagnetism detected by magnetic sensor 101 based on information 600 indicating the movement of the vehicle, for example, information about the steering angle sensor, information about the acceleration sensor installed in a place different from electronic compass device for a vehicle 100, and information about acceleration sensor 102 configured to detect the movement of electronic compass device for a vehicle 100.

FIG. 4 is a block diagram illustrating a configuration of portable electronic compass calibration device 200. Portable electronic compass calibration device 200 includes, as illustrated in FIG. 4, electronic compass 201 having a calibration function, acceleration sensor 202 configured to detect the movement of portable electronic compass calibration device 200, camera 203, display 206 configured to display an image and the like obtained by acquiring an image by the camera, input unit 207 configured to input an operation command and the like, wireless communication unit 204, near field communication unit 205, and controller 208 configured to control the whole of portable electronic compass calibration device 200.

Electronic compass 201 has a function of performing the calibration of the bearing to be detected by the movement in a predetermined direction, for example, the movement of drawing a figure-of-eight in three dimensions.

Wireless communication unit 204 communicates with wireless communication unit 103 of electronic compass device for a vehicle 100 based on, for example, Bluetooth (registered trademark). In addition, near field communication unit 205 communicates with near field communication unit 104 of electronic compass device for a vehicle 100 based on, for example, NFC.

Controller 208 identifies the direction of portable electronic compass calibration device 200 by an output of acceleration sensor 202, and displays the bearing detected by electronic compass 201 on display 206 depending on the direction of portable electronic compass calibration device 200.

Controller 208 includes a CPU configured to control operation, a ROM configured to store a control program, and a RAM configured to store data to be temporarily held and control data.

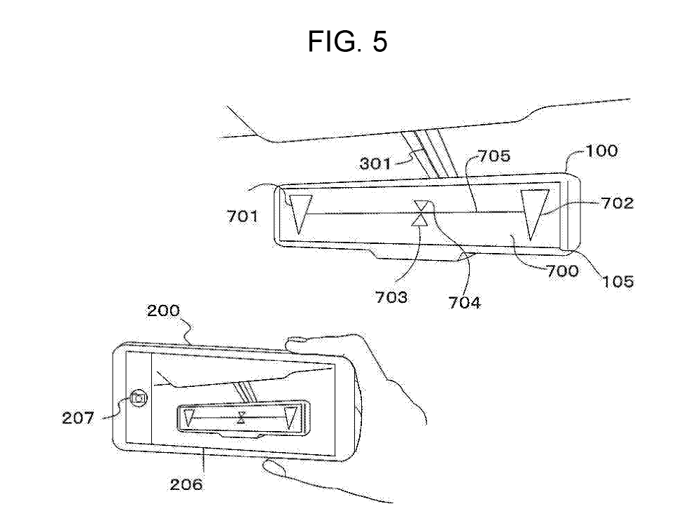

Next, an example of main operations of electronic compass device for a vehicle 100 and portable electronic compass calibration device 200 in the present exemplary embodiment will be described. FIG. 5 is a diagram illustrating the operations of electronic compass device for a vehicle 100 and portable electronic compass calibration device 200.

After the bearing calibration of electronic compass 201, portable electronic compass calibration device 200 acquires compass calibration screen 700 displayed by electronic compass device for a vehicle 100 and centerline 301 of coupling body 300 as one image.

On compass calibration screen 700, a figure for portable electronic compass calibration device 200 identifying the relative position of electronic compass device for a vehicle 100 with respect to portable electronic compass calibration device 200 is displayed.

On compass calibration screen 700, for example, triangles 703 and 704 indicating the center of electronic compass device for a vehicle 100 are displayed, isosceles triangles 701, 702 are displayed on both end sides, and straight line 705 connecting isosceles triangles 701 and 702, passing through the center is displayed.

Portable electronic compass calibration device 200 calculates the difference between the distance from the center in compass calibration screen 700 obtained by acquiring an image to isosceles triangle 701 and the distance from the center to isosceles triangle 702, and the relative position of electronic compass device for a vehicle 100 based on the change in the shapes of isosceles triangles 701, 702. That is, portable electronic compass calibration device 200 identifies in which direction electronic compass device for a vehicle 100 is with respect to portable electronic compass calibration device 200.

In addition, portable electronic compass calibration device 200 identifies the traveling direction of the vehicle with respect to portable electronic compass calibration device 200 based on the change in the acquired shape of centerline 301 of coupling body 300 disposed on the windshield of the vehicle.

Portable electronic compass calibration device 200 calculates the position of electronic compass device for a vehicle 100 with respect to the traveling direction of the vehicle from the relative position of electronic compass device for a vehicle 100 and the traveling direction of the vehicle with respect to portable electronic compass calibration device 200.

Portable electronic compass calibration device 200 calculates the bearing in the traveling direction of the vehicle to be displayed by electronic compass device for a vehicle 100 based on the bearing of electronic compass 201 at the time of acquiring an image, the traveling direction of the vehicle with respect to portable electronic compass calibration device 200 at the time of acquiring an image, and the position of electronic compass device for a vehicle 100 with respect to the traveling direction of the vehicle at the time of acquiring an image.

Portable electronic compass calibration device 200 transmits the calculated bearing from wireless communication unit 204 to wireless communication unit 103 of electronic compass device for a vehicle 100.

Electronic compass device for a vehicle 100 displays the bearing received by wireless communication unit 103 on display unit 105.

After this, electronic compass device for a vehicle 100 calibrates the bearing in the traveling direction of the vehicle based on the received bearing to display the bearing after the calibration on display unit 105.

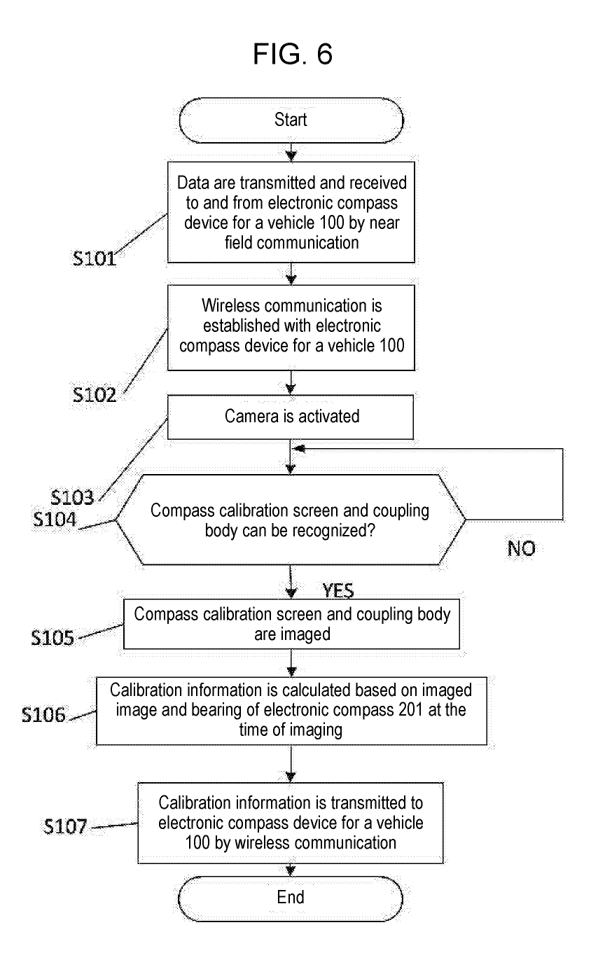

FIG. 6 is a flowchart illustrating in more detail an example of the operation of portable electronic compass calibration device 200 described with reference to FIG. 5.

As described above, the calculation of the calibration data of electronic compass device for a vehicle 100 is performed after the calibration of the bearing of electronic compass 201.

After the calibration of electronic compass 201, portable electronic compass calibration device 200 performs transmission and reception of data with electronic compass device for a vehicle 100 by the communication based on NFC by near field communication unit 205 with near field communication unit 104 of electronic compass device for a vehicle 100 (step S101).

Specifically, portable electronic compass calibration device 200 transmits a Bluetooth (registered trademark) address of portable electronic compass calibration device 200 and a command for instructing the display of the compass calibration screen to electronic compass device for a vehicle 100, and receives a Bluetooth (registered trademark) address of electronic compass device for a vehicle 100 from electronic compass device for a vehicle 100.

Portable electronic compass calibration device 200 establishes the communication based on Bluetooth (registered trademark) with electronic compass device for a vehicle 100 by using the address of electronic compass device for a vehicle 100 (step S102).

Portable electronic compass calibration device 200 activates the camera (step S103).

Controller 208 determines whether or not compass calibration screen 700 displayed by electronic compass device for a vehicle 100 and centerline 301 of the coupling body can be recognized in the image acquired by the camera (step S104). The determination is repeated until compass calibration screen 700 and centerline 301 of the coupling body can be recognized (NO in step S104).

When compass calibration screen 700 and centerline 301 of the coupling body are recognizable (YES in step S104), the camera acquires an image, and the bearing at the time of the acquiring an image of electronic compass 201 is stored (step S105).

Controller 208 calculates the bearing in the traveling direction of the vehicle to be displayed by electronic compass device for a vehicle 100 based on the acquired image and the bearing of electronic compass 201 at the time of the acquiring an image (step S106).

The calculated bearing is transmitted to electronic compass device for a vehicle 100 by the communication based on Bluetooth (registered trademark) (step S107), and the processing ends.

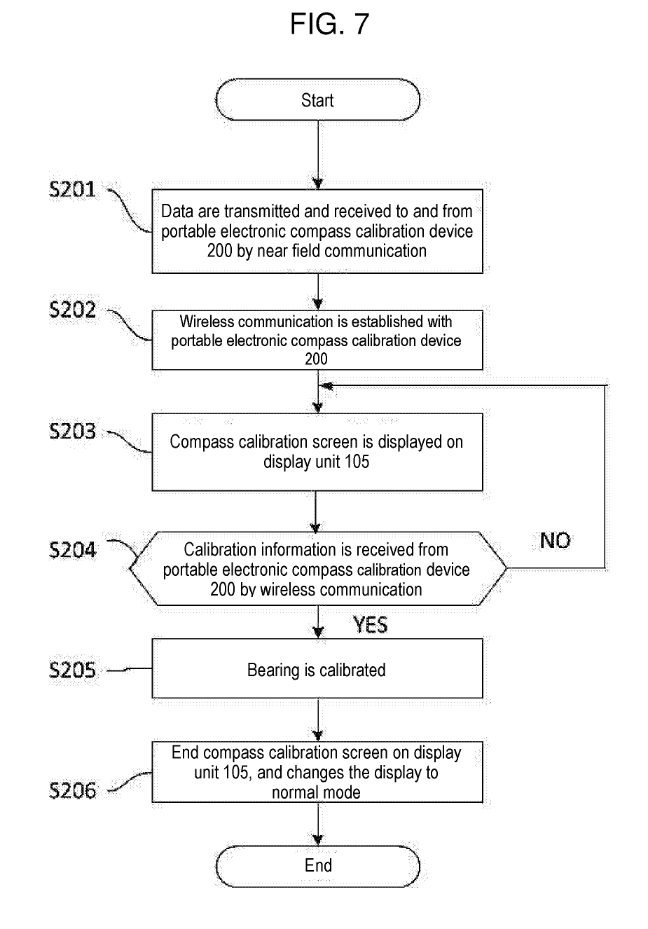

FIG. 7 is a flowchart illustrating in more detail an example of the operation of electronic compass device for a vehicle 100 described with reference to FIG. 5.

The descriptions of steps S201, S202 overlapping with the description of FIG. 6 will be omitted. Electronic compass device for a vehicle 100 displays compass calibration screen 700 on display unit 105 in accordance with the command to display the image for compass calibration received by NFC (step S203).

Electronic compass device for a vehicle 100 displays compass calibration screen 700 until receiving the calibration information from portable electronic compass calibration device 200 (NO in step S204).

When the calibration information is received (YES in S204), electronic compass device for a vehicle 100 calibrates the bearing in the traveling direction of the vehicle displayed on display unit 105 based on the received calibration information (step S205).

Electronic compass device for a vehicle 100 changes the display on display unit 105 from the compass calibration screen to the normal display (step S206), and ends the processing.

As a normal display, for example, the bearing in the traveling direction of the vehicle and the image acquired by the camera are displayed.

As described above, according to electronic compass device for a vehicle 100 in the present exemplary embodiment, calibration information is received from portable electronic compass calibration device 200 including electronic compass 201 having a calibration function, and the bearing in the traveling direction of the vehicle to be displayed on display unit 105 is calibrated based on the received calibration information, and therefore the bearing in the traveling direction of the vehicle can be calibrated without moving of the vehicle.

In addition, a display screen image on display unit 105 is identifiably divided into region 105a for displaying the camera image and region 105b for displaying the bearing in the traveling direction of the vehicle, and display unit 105 is configured to intermittently display the bearing in the traveling direction of the vehicle. This enhances the visibility as the electronic mirror, and allows the image burn-in to be prevented.

In addition, in portable electronic compass calibration device 200, first, electronic compass 201 due to the movement in a predetermined direction is calibrated. Then, the compass calibration screen of electronic compass device for a vehicle 100 and coupling body 300 are acquired as one image. The bearing in the traveling direction of the vehicle to be displayed by electronic compass device for a vehicle 100 is calculated by using the image and the output of the calibrated electronic compass at the time of acquiring the image. Then, the calculation result is transmitted to electronic compass device for a vehicle 100 as the calibration information. This allows the bearing in the traveling direction of the vehicle of the electronic compass device for a vehicle 100 to be calibrated without moving of the vehicle.

### INDUSTRIAL APPLICABILITY

The electronic compass device for a vehicle of the present invention is useful as a driving support device for correctly displaying the bearing in the traveling direction of the vehicle before the driving starts.

### REFERENCE MARKS IN THE DRAWINGS

100: electronic compass device for a vehicle
101: magnetic sensor
102, 202: acceleration sensor
103, 204: wireless communication unit
104, 205: near field communication unit
105: display unit
105a, 105b: region
106, 208: controller
107: operation unit
117: mark
200: portable electronic compass calibration device
201: electronic compass
203: camera
206: display
207: input unit
300: coupling body
301: centerline
400: vehicle
500: camera image
600: information
700: compass calibration screen
701, 702: isosceles triangle
703, 704: triangle
705: straight line

1. An electronic compass device for a vehicle installed in an attachment position of a rearview mirror inside a vehicle interior, and connected to a coupling body disposed on a windshield of the vehicle in parallel with a centerline of the vehicle, the electronic compass device for a vehicle comprising:
a communication unit configured to communicate with a portable electronic compass calibration device including an electronic compass having a calibration function;
a display unit configured to display a bearing in a traveling direction of the vehicle; and
a controller configured to control the communication unit and the display unit,
wherein the display unit displays a compass calibration screen in accordance with a signal received by the communication unit from the portable electronic compass calibration device,
the communication unit receives calibration information obtained by a calculation performed by the portable electronic compass calibration device by using an acquired image of the compass calibration screen and the coupling body, and a bearing of the electronic compass at a time of acquiring of the acquired image after calibration of the portable electronic compass calibration device, and
the controller calibrates the bearing in the traveling direction of the vehicle to be displayed on the display unit, based on the calibration information.

2. The electronic compass device for a vehicle according to claim 1, wherein the display unit is connected by the coupling body, and displays an image acquired by a camera mounted on the vehicle.

3. The electronic compass device for a vehicle according to claim 2, wherein a display screen image of the display unit is identifiably divided into a region for displaying the image acquired by the camera and a region for displaying the bearing in the traveling direction of the vehicle, and the display unit is configured to intermittently display the bearing in the traveling direction of the vehicle.

4. A portable electronic compass calibration device comprising:
a communication unit configured to communicate with an electronic compass device for a vehicle;
an electronic compass having a calibration function;
a camera;
a display unit configured to display an image acquired by the camera; and
a controller configured to control the communication unit, the electronic compass, the camera, and the display unit,
wherein the camera acquires a compass calibration screen to be displayed by the electronic compass device for a vehicle and a coupling body disposed on a windshield of the vehicle in parallel with a centerline of the vehicle connected to the electronic compass device for a vehicle as one image,
the controller calculates a bearing in a traveling direction of the vehicle to be displayed by the electronic compass device for a vehicle, based on the image and an output of the electronic compass after calibration at a time of acquiring of the image, and
the communication unit transmits a command for instructing a display of the compass calibration screen and the bearing calculated by the controller to the electronic compass device for a vehicle.

5. A non-transitory machine-readable recording medium that stores a program configured to cause a computer to realize a control for a portable electronic compass calibration device including an electronic compass having a calibration function, the control program for causing a computer included in the portable electronic compass calibration device to execute:
a step of instructing an electronic compass device for a vehicle to display a compass calibration screen, the electronic compass device for a vehicle being installed in an attachment position of a rearview mirror inside a vehicle interior, and connected to a coupling body disposed on a windshield of the vehicle in parallel with a centerline of the vehicle;
a step of recognizing, in one image acquired by a camera, the compass calibration screen to be displayed by the electronic compass device for a vehicle and the coupling body disposed on the windshield of the vehicle in parallel with the centerline of the vehicle connected to the electronic compass device for a vehicle;
a step of acquiring the recognized compass calibration screen and the recognized coupling body as one image;
a step of calculating a bearing in a traveling direction of the vehicle to be displayed by the electronic compass device for a vehicle, based on the image and an output of the electronic compass after calibration at a time of acquiring of the image; and
a step of transmitting the calculated bearing to the electronic compass device for a vehicle.

6. An electronic compass calibration system for a vehicle, comprising:
the electronic compass device for a vehicle according to claim 1; and
the portable electronic compass calibration device comprising:
a communication unit configured to communicate with an electronic compass device for a vehicle;
an electronic compass having a calibration function;
a camera;
a display unit configured to display an image acquired by the camera; and
a controller configured to control the communication unit, the electronic compass, the camera, and the display unit,
wherein the camera acquires a compass calibration screen to be displayed by the electronic compass device for a vehicle and a coupling body disposed on a windshield of the vehicle in parallel with a centerline of the vehicle connected to the electronic compass device for a vehicle as one image,
the controller calculates a bearing in a traveling direction of the vehicle to be displayed by the electronic compass device for a vehicle, based on the image and an output of the electronic compass after calibration at a time of acquiring of the image, and
the communication unit transmits a command for instructing a display of the compass calibration screen and the bearing calculated by the controller to the electronic compass device for a vehicle.
